(19) United States
(12) Patent Application Publication
(10) Pub. No.: US 2021/0092545 A1
(43) Pub. Date: Mar. 25, 2021

(54) AUDIO PROCESSING

(71) Applicant: Nokia Technologies Oy, Espoo (FI)

(72) Inventors: Jussi LEPPÄNEN, Tampere (FI); Arto LEHTINIEMI, Lempäälä (FI); Antti ERONEN, Tampere (FI); Sujeet Shyamsundar MATE, Tampere (FI)

(21) Appl. No.: 15/734,981

(22) PCT Filed: Jun. 18, 2019
(86) PCT No.: PCT/EP2019/066050

§ 371 Date: Dec. 3, 2020

(30) Foreign Application Priority Data
Jun. 28, 2018 (EP) 18180374.3

(51) Int. Cl. H04S 7/00

(52) U.S. Cl. CPC H04S 7/303; H04S 7/308; H04S 2420/01; H04S 2400/01; H04S 2400/11; H04S 7/40

(57) ABSTRACT

An apparatus is disclosed, which comprises a means for identifying virtual audio content within a first spatial sector of a virtual space with respect to a reference position. The apparatus also comprises a means for modifying the identified virtual audio content to be rendered in a second, smaller spatial sector.

### FIELD

Example embodiments relate to audio processing, for example processing of volumetric audio content for rendering to user equipment.

### BACKGROUND

Volumetric audio refers to signals or data (“audio content”) representing sounds which may be rendered in a three-dimensional space. The rendered audio may be explored responsive to to user action. For example, the audio content may correspond to a virtual space in which the user can move such that the user perceives sounds that change depending on the user's position and/or orientation. Volumetric audio content may therefore provide the user with an immersive experience. The volumetric audio content may or may not correspond to video data in a virtual reality (VR) space or similar. The user may wear a user device such as headphones or earphones which outputs the volumetric audio content based on position and/or orientation. The user device may be a virtual reality headset which incorporates headphones and possibly video screens for corresponding video data. Position sensors may be provided in the user device, or another device, or position may be determined by external means such as one or more sensors in the physical space in which the user moves. The user device may be provided with a live or stored feed of the audio and/or video.

### SUMMARY

An embodiment according to a first aspect comprises an apparatus comprising: means for identifying virtual audio content within a first spatial sector of a virtual space with respect to a reference position; and means for modifying the identified virtual audio content to be rendered in a second, smaller spatial sector.

The modifying means may be configured such that the second spatial sector is wholly within the first spatial sector.

The modifying means may be configured such that virtual audio content outside of the first spatial sector is not modified or is modified differently than the identified virtual audio content.

The modifying means may be configured to provide the virtual audio content to a first user device associated with a user, the apparatus further comprising means for detecting a predetermined first condition of a second user device associated with the user, and wherein the modifying means is configured to modify the identified virtual audio content responsive to detection of the predetermined first condition.

The apparatus may further comprise means for detecting a predetermined second condition of the first or second user device, and wherein the modifying means is configured, if the virtual audio content has been modified, to revert back to rendering the identified virtual audio content in unmodified form responsive to detection of the predetermined second condition.

The identifying means may be configured to identify one or more audio sources, each associated with respective virtual audio content, being within the first spatial sector, and the modifying means may be configured to modify the spatial position of the virtual audio content to be rendered from within the second spatial sector.

The apparatus may further comprise means to receive a current position of a user device associated with a user in relation to the virtual space, the identifying means being configured to use said current position as the reference position and to determine the first spatial sector as an angular sector of the space for which the reference position is the origin.

The modifying means may be configured such that the second spatial sector is a smaller angular sector of the space for which the reference position is also the origin.

The identifying means may be configured such that the determined angular sector is based on the movement or distance of the user device with respect to a user.

The modifying means may be configured to move the respective spatial positions of the identified virtual audio content by means of translation towards a line passing through the centre of the first or second spatial sectors.

The modifying means may be configured to move the respective spatial positions of the identified virtual audio content for the identified audio sources by means of rotation about an arc of substantially constant radius from the reference position.

The apparatus may further comprise means for rendering virtual video content in association with the virtual audio content, in which the virtual video content for the identified audio content is not spatially modified.

In the above, the means may comprise: at least one processor; and at least one memory including computer program code, the at least one memory and computer program code configured to, with the at least one processor, cause the performance of the apparatus.

An embodiment according to a further aspect provides a method, comprising: identifying virtual audio content within a first spatial sector of a virtual space with respect to a reference position; and modifying the identified virtual audio content to be rendered in a second, smaller spatial sector.

An embodiment according to a further aspect provides a computer program comprising instructions that when executed by a computer apparatus control it to perform the method of: identifying virtual audio content within a first spatial sector of a virtual space with respect to a reference position; and modifying the identified virtual audio content to be rendered in a second, smaller spatial sector.

An embodiment according to a further aspect provides apparatus comprising at least one processor and at least one memory including computer program code, the at least one memory and computer program code configured to, with the at least one processor, cause the apparatus to: identify virtual audio content within a first spatial sector of a virtual space with respect to a reference position; modify the identified virtual audio content to be rendered in a second, smaller spatial sector.

The computer program code may be further configured, with the at least one processor, to cause the apparatus to modify the identified virtual audio content such that the second spatial sector is wholly within the first spatial sector.

The computer program code may be further configured, with the at least one processor, to cause the apparatus to operate such that virtual audio content outside of the first spatial sector is not modified or is modified differently than the identified virtual audio content.

The computer program code may be further configured, with the at least one processor, to cause the apparatus to provide the virtual audio content to a first user device associated with a user, to detect a predetermined first condition of a second user device associated with the user, and to modify the identified virtual audio content responsive to detection of the predetermined first condition.

The computer program code may be further configured, with the at least one processor, to cause the apparatus to detect a predetermined second condition of the first or second user device, and, if the virtual audio content has been modified, to revert back to rendering the identified virtual audio content in unmodified form responsive to detection of the predetermined second condition.

The computer program code may be further configured, with the at least one processor, to cause the apparatus to identify one or more audio sources, each associated with respective virtual audio content, being within the first spatial sector, and to modify the spatial position of the virtual audio content to be rendered from within the second spatial sector.

The computer program code may be further configured, with the at least one processor, to cause the apparatus to receive a current position of a user device associated with a user in relation to the virtual space, to use said current position as the reference position and to determine the first spatial sector as an angular sector of the space for which the reference position is the origin.

The computer program code may be further configured, with the at least one processor, to cause the apparatus to determine the second spatial sector as a smaller angular sector of the space for which the reference position is also the origin.

The computer program code may be further configured, with the at least one processor, to cause the apparatus to determine the angular sector based on the movement or distance of the user device with respect to a user.

The computer program code may be further configured, with the at least one processor, to cause the apparatus to move the respective spatial positions of the identified virtual audio content by means of translation towards a line passing through the centre of the first or second spatial sectors.

The computer program code may be further configured, with the at least one processor, to cause the apparatus to move the respective spatial positions of the identified virtual audio content for the identified audio sources by means of rotation about an arc of substantially constant radius from the reference position.

The computer program code may be further configured, with the at least one processor, to cause the apparatus to render virtual video content in association with the virtual audio content, in which the virtual video content for the identified audio content is not spatially modified.

An embodiment according to a further aspect comprises a method, comprising: identifying virtual audio content within a first spatial sector of a virtual space with respect to a reference position; and modifying the identified virtual audio content to be rendered in a second, smaller spatial sector.

The identified virtual audio content may be modified such that the second spatial sector is wholly within the first spatial sector.

The virtual audio content outside of the first spatial sector may not be modified or is modified differently than the identified virtual audio content.

The method may further comprise providing the virtual audio content to a first user device associated with a user, detecting a predetermined first condition of a second user device associated with the user, and modifying the identified virtual audio content responsive to detection of the predetermined first condition.

The method may further comprise detecting a predetermined second condition of the first or second user device, and, if the virtual audio content has been modified, reverting back to rendering the identified virtual audio content in unmodified form responsive to detection of the predetermined second condition.

The first user device referred to above may be a headset, earphones or headphones. The second user device may be a mobile communications terminal.

The method may further comprise rendering virtual video content in association with the virtual audio content, in which the virtual video content for the identified audio content is not spatially modified.

An embodiment according to a further aspect provides a computer program comprising instructions that when executed by a computer apparatus control it to perform the method of: identifying virtual audio content within a first spatial sector of a virtual space with respect to a reference position; and modifying the identified virtual audio content to be rendered in a second, smaller spatial sector.

### BRIEF DESCRIPTION OF DRAWINGS

Example embodiments will now be described, by way of non-limiting example, with reference to the accompanying drawings, in which:

FIG. 1 is a schematic view of an apparatus according to example embodiments in relation to real and virtual spaces;

FIG. 2 is a schematic block diagram of the apparatus shown in FIG. 1;

FIG. 3 is a top plan view of a space comprising audio sources rendered by the FIG. 1 apparatus and a first spatial sector determined according to an example embodiment;

FIG. 4 is a top plan view of the FIG. 3 space with one or more audio sources moved to a second spatial sector according to an example embodiment;

FIG. 5 is a top plan view of the FIG. 3 space with one or more audio sources moved to a second spatial sector according to another example embodiment;

FIG. 6 is a top plan view of a space comprising audio sources rendered by the FIG. 1 apparatus and another first spatial sector determined according to an example embodiment;

FIG. 7 is a flow diagram showing processing operations according to an example embodiment;

FIG. 8 is a flow diagram showing processing operations according to another example embodiment;

FIG. 9 is a flow diagram showing processing operations according to another example embodiment;

FIG. 10 is a schematic block diagram of a system for synthesising binaural audio output; and

FIG. 11 is a schematic block diagram of a system for synthesising frequency bands in a parametric spatial audio representation, according to example embodiments.

### DETAILED DESCRIPTION

Example embodiments relate to methods and systems for audio processing, for example processing of volumetric audio content.

The volumetric audio content may correspond to a virtual space which includes virtual video content, for example a three-dimensional virtual space which may comprise one or more virtual objects. One or more of said virtual objects may be sound sources, for example people or objects which produce sounds in the virtual space. The sound sources may move over time. When rendered to a user device, one or more users may perceive the audio content coming from directions appropriate to the user's current position or movement. It will be appreciated that the audio perception may change as the user changes position and/or as the objects change position. In this context, user position may refer to both the user's spatial position in the virtual space and/or their orientation.

Typically, the user device will be a set of headphones, earphones or a headset incorporating audio transducers such as the above. The headset may include one or more screens if also providing rendered video content to the user.

In terms of positioning, the user device may use so-called three degrees of freedom (3 DoF), which means that head movement in the yaw, pitch and roll axes are measured and determine what the user hears and/or sees. This facilitates the audio and/or video content remaining largely static in a single location as the user rotates their head. A next stage may be referred to as 3 DoF+ which may facilitate limited translational movement in Euclidean space in the range of, e.g. tens of centimetres, around a location. A yet further stage is a six degrees-of-freedom (6 DoF) system, where the user is able to freely move in the Euclidean space and rotate their head in the yaw, pitch and roll axes. A six degrees-of-freedom system enables the provision and consumption of volumetric content, which is the focus of this application but the other systems may also find useful application of embodiments described herein. Thus, a user will be able to move relatively freely within a virtual space and hear and/or see objects from different directions, and even move behind objects.

Another method of positioning a user is to employ one or more tracking sensors within the real world space that the user is situated in. The sensors may comprise cameras.

In the context of this specification, audio signals or data that represent sound in a virtual space is referred to as virtual audio content.

In the situation where the virtual space comprises virtual audio content from potentially many different directions, for example from multiple audio sources, the immersive experience can be complex. For example, a user may wish to experience some audio sources having corresponding video content up-close, but to do so will result in close-by sounds coming from potentially many angles.

Example embodiments relate to systems and methods involving identifying audio content from within a first spatial sector of a virtual space and modifying the identified audio content to be rendered in a second, smaller spatial sector. For example, embodiments may relate to applying a virtual wide-angle lens effect whereby audio content detected with the first spatial sector is processed such that is transformed to be perceived within the second, smaller spatial sector. This may involve moving the position of the audio content from the first spatial sector to the second spatial sector, and this may involve different movement methods.

For example, in one embodiment, the movement of the audio content is by means of translation towards a line passing through the centre of the first and/or second spatial sectors. In another embodiment, the movement of the audio content is by means of movement along an arc of substantially constant radius from the reference position.

The reference position may be the position of a user device, such as a mobile phone or other portable device which may be different from the means of consuming the audio content or video content, if provided. The reference position may determine the origin of the first and/or second spatial sectors. The first and/or second spatial sectors can be any two or three-dimensional areas/volumes within the virtual space, and typically will be defined by an angle or solid angle from the origin position.

The processing of example embodiments may be applied selectively, for example in response to a user action. For example, the user action may be associated with the user device, such as is a mobile phone or other portable device. For example, the user action may involve a user pressing a hard or soft button on the user device, or the user action may be responsive to detecting a certain predetermined movement or gesture of the user device, or the user device being removed from the user's pocket. In the latter case, the user device may comprise a light sensor which detects the intensity of ambient light to determine if the device is inside or outside a pocket.

Furthermore, the angle or solid angle of the first spatial sector may be adjusted based on user action or some other variable factor. For example, the distance of the user device from the user position may determine how wide the angle or solid angle is. In this respect, it may be appreciated that the user position may be different from that of the user device. The user position may be based on the position of their headset, earphones or headphones, or by an external sensing or tracking system within the real world space. The position of the user device, e.g. a smartphone, may move in relation to the user position. The position of the user device may be determined by similar indoor sensing or tracking means, suitably configured to distinguish the user device from the user, and/or by an in-built position sensor such as a global positioning system (GPS) receiver or the like.

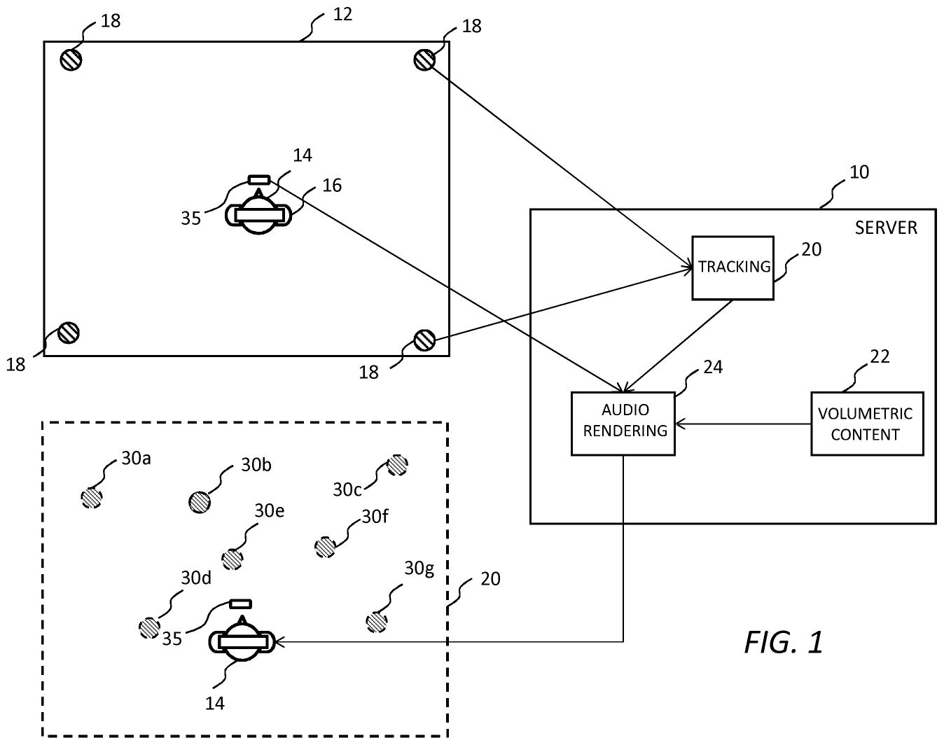

Referring to FIG. 1, a scenario is shown, representing consumption of volumetric audio, in association with a server 10 according to example embodiments. The server 10 may be one device or comprised of multiple devices which may be located in the same or at different locations. The server 10 may comprise a tracking module 20, a volumetric content module 22 and an audio rendering module 24. In other embodiments, a fewer or greater number of modules may be provided. The tracking module 20, volumetric content module 22 and audio rendering module 24 may be provided in the form of hardware, software or a combination thereof.

FIG. 1 shows a real-world space 12 in top plan view, which space may be a room or hall of any suitable size within which a user 14 is physically located. The user 14 may be wearing a first user device 16 which may comprise earphones, headphones or similar audio transducing means. The first user device 16 may be a virtual reality headset which also incorporates one or more video screens for displaying video content. The user 14 may also have an associated second user device 35 which may be in communication with the audio rendering module 24, to either directly or indirectly, for indicating its position or other state to the server 10. The reason for this will become clear later on.

In some embodiments, the real-world space 12 may comprise one or more position determining means 18 for tracking the position of the user 14. There are a number of systems for performing this, including camera systems that can recognise and track objects, for example based on depth analysis. Other systems may include the use of high accuracy indoor positioning (HAIP) locators which work in association with one or more HAIP tags carried by the user 14. Other systems may employ inside-out tracking, which may be embodied in the first user device 16, or global positioning receivers (e.g. GPS receiver or the like) which may be embodied on the first user device 160r on another user device such as a mobile phone.

Whichever system for position tracking is used, the positional data representing the spatial position of the user 14, and possibly including head or gaze orientation, is provided to the tracking module 20. The tracking module 20 is configured to determine in real-time or near real-time the position of the user 14 in relation to data stored in the volumetric content module 22 such that a change in position is reflected in the volumetric content fed to the first user device 16, which may be by means of streaming. The audio rendering module 24 is configured to receive the tracking data from the tracking module 20 and to render audio data from the volumetric content module 22 in dependence on the tracking data. The volumetric content module 22 processes the audio data and transmits it to the user 14 who perceives the rendered, position-dependent audio, through the first user device 16.

Here, a virtual world 20 is represented in FIG. 1 separately, as is the current position of the user 14. The virtual world 20 may be comprised of virtual video content as well as volumetric audio content. This is not essential, however. In this case, the volumetric audio content comprises audio content from seven audio sources 30a-30g, which may correspond to virtual visual objects. The seven audio sources 30a-30g may comprise members of a music band, or actors in a play, for example. The video content corresponding to the seven audio sources 30a-30g may be received from the volumetric content module 22 also. The respective positions of the seven audio sources 30a-30g are indicative of the direction of arrival of their sounds relative to the current position of the user 14.

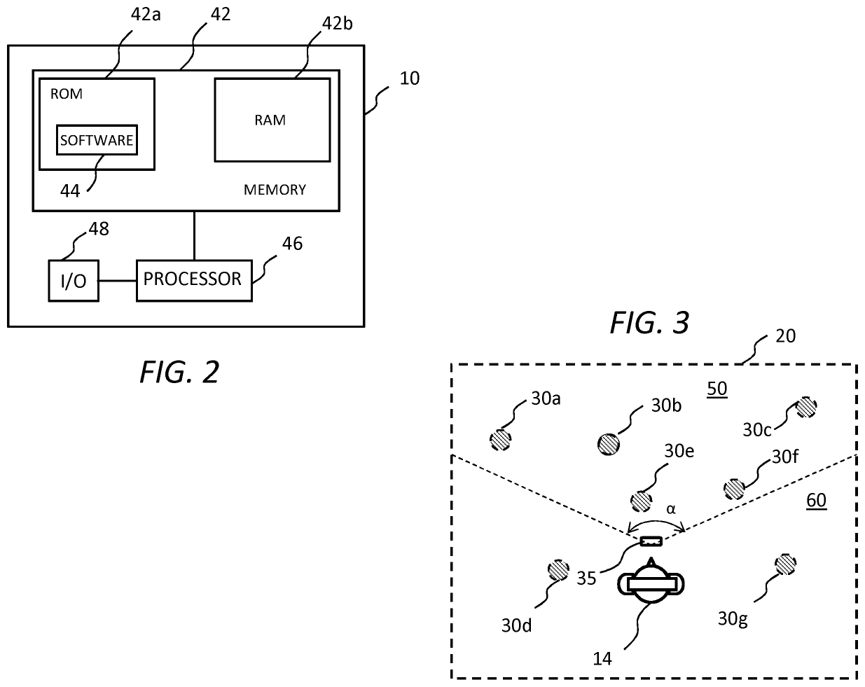

FIG. 2 shows an apparatus according to an embodiment. The apparatus may provide the functional modules of the server 10 indicated in FIG. 1. The apparatus comprises at least one processor 46 and at least one memory 42 directly or closely connected to the processor. The memory 42 includes at least one random access memory (RAM) 42b and at least one read-only memory (ROM) 42a. Computer program code (software) 44 is stored in the ROM 42a. The processor 46 may be connected to an input and output interface for the reception and transmission of data, for example the positional data and the rendered virtual audio and/or video data to the first user device 14. The at least one processor 46, with the at least one memory 42 and the computer program code 44 may be arranged to cause the apparatus to at least perform at least operations described herein.

The at least one processor 46 may comprise a microprocessor, a controller, or plural microprocessors and plural controllers.

Referring back to FIG. 1, consider the scenario where the user 14 transitions to the shown position in order to experience a close-up visual view of all seven (or a subset of the) audio sources 30a-30g. From the audio experience point of view, this may not be optimal, because the rendered audio from the close-up audio sources 30a-30g will come from all around and from close-by. This may be disturbing and detract from the user's experience. Moving away from the close-up position detracts from the desired visual view.

Embodiments herein therefore employ a virtual wide-angle lens for transforming the volumetric audio scene such that audio content from within a first spatial area is spatially re-positioned to be within a smaller, e.g. narrower, spatial area.

For example, FIG. 3 shows the top-plan view of the FIG. 1 virtual world 20. A first spatial area 50 may be determined as distinct from the remainder of the rendered spatial area, indicated by reference numeral 60. The first spatial area 50 may be determined based on an origin position, which in this case is the position of a second user device 35 which is a mobile phone of the user 14. Based on knowledge of the position of the second user device 35, a predetermined or adaptive angle α may be determined by the server 10 to provide the first spatial area 50. This may be a solid angle when considered in three-dimensions. The server 10 may then determine that any of the sound sources 30a-30g falling within said first spatial area 50 are selected for transformation at an audio level (although not necessarily at the video level). Thus, the outside, or ambient, audio sources 30d, 30g will not be transformed by the server 10.

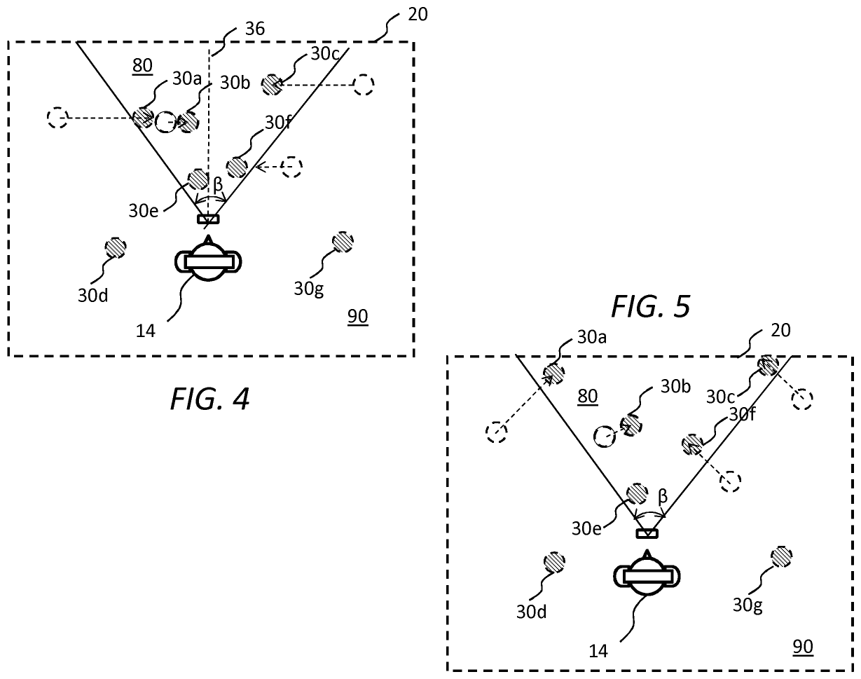

FIG. 4 shows the FIG. 3 virtual world 20 at a subsequent stage of operation of an example embodiment. A second spatial area 80, which is a smaller than the first spatial area 50, is determined, and the above transformation of the selected spatial sources 30a, 30b, 30c, 30e, 30f is such that their corresponding audio content is spatially repositioned to be within the second spatial area. In some embodiments, the second spatial area 80 may be entirely within the first spatial area 50 as shown. The shown second spatial area 80 has an angle β which represents a more condensed or focussed version of the first spatial area 50 in terms of the audio content represented therein. There is therefore a spectral shrinking of audio content from the selected spatial sources 30a, 30b, 30c, 30e, 30f, which can lead to an improved audio experience and does not require the user 14 to move away in order to achieve this.

As mentioned previously, there may be a mismatch of the audio from the selected spatial sources 30a, 30b, 30c, 30e, 30f and their corresponding visual content, but the reason for the mismatch is clear and understood by the user 14.

There are a number of ways in which the server 10 may perform the transformation. For example, as shown in FIG. 4, repositioning of the selected audio sources 30a, 30b, 30c, 30e, 30f may be by means of translation of said selected audio sources towards a centre line 36 passing through the centre of the first and/or second spatial areas 40, 80. For example, as an alternative, repositioning of the selected audio sources 30a, 30b, 30c, 30e, 30f may be by means of movement along an arc of constant radius from the origin of the first and second spatial areas 40, 80. This is indicated for completeness in FIG. 5.

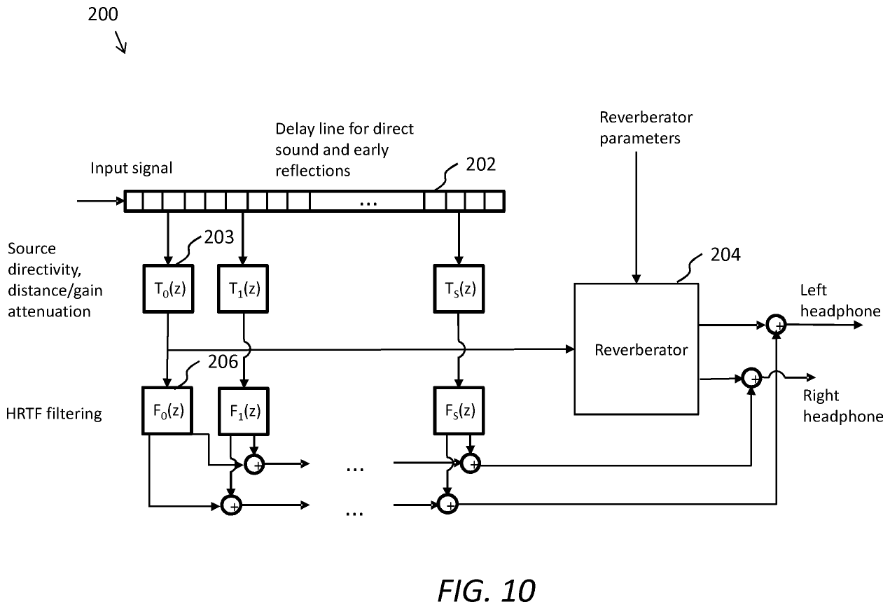

In some other embodiments, lens simulation and/or raytracing methods can be used to simulate the behavior of light rays when a certain wide-angle lens is used, and this can be used to reposition the selected spatial sources 30a, 30b, 30c, 30e, 30f. For audio rendering, the spatial sources 30a, 30b, 30c, 30e, 30f may then be returned by inverse translation to the user-centric coordinate system and the rendering is done as normal. For example, the method depicted in FIG. 10, described later on, can be used. When a spatial source 30a, 30b, 30c, 30e, 30f is moved in the space, the HRFT filtering takes care of positioning it at the correct direction with respect to the user's head. The distance/gain attenuation takes care of adjusting the source distance.

In some embodiments, initiation of the virtual wide-angle lens system and method as described above may be responsive to user action and/or the size or angular extent of a may be based on user action. For example, the system and method according to preferred embodiments may be linked to the second user device 35, i.e. the user's mobile phone.

For example, if the second user device 35 is within the user's pocket (detectable e.g. by means of a light sensor and/or orientation sensor) then the system and method may be initially disabled. If however the user removes the second user device 35 from their pocket (detectable by sensed light intensity being above a predetermined level, or similar) then the system and method may be enabled and the spatial transformation of the audio sources performed as above.

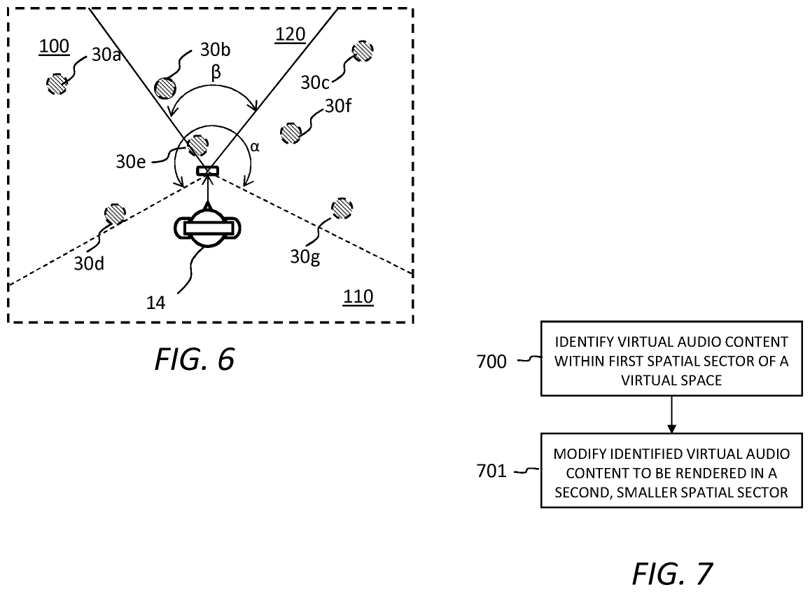

For example, the angle α may be based on the distance of the second user device 35 from the user 14. For example, the greater the distance the wider the value of α. Thus, by moving the second user device 35 back and forth towards the user 14, the value of α may get smaller or larger. For example, as shown in FIG. 6, movement of the second user device 35 further is away from the user 14 may result in an angle α of greater than 180 degrees, which would in this case cover all of the shown audio sources 30a-30g for transformation.

Other examples of selecting enabling and disabling, and setting the angle α may be by means of user control of a hard or soft switch on an application of the second user device 35.

Additionally, or alternatively, the value of β may be controlled by means of the above or similar methods, e.g. based on the position of the second user device 35 relative to the user 14 or by means of control of an application.

Default settings of the first and second angles α and β may be provided in the audio stream from the server 10 in some embodiments. A content creator may therefore define the wide-angle lens effect, including parts of the virtual world to which the effect will be applied, the type and strength of transformation and for which user listening positions. These may be fixed or modifiable by means of the above second user device 35.

Upon enablement of the method and system for transforming the audio content, replacing the second user device 35 into the initial state, i.e. placing it back into the user's pocket, may allow the transformation effect to continue. If the user 14 subsequently repositions themselves from their current position by a certain amount, e.g. beyond a threshold, then the method and system for transforming the audio content by be disabled and the positions of the audio sources 30a, 30b, 30c, 30e, 30f may return to their previous respective positions.

The second user device 35 may be any form of portable user device, and may typically be different from the first user device 16 which outputs sound to the user 14. It may for example be a mobile phone, smartphone or tablet computer.

Returning to FIG. 1, it will be seen that an arrow is shown between the second user device 35 and the audio rendering module 24. This is indicative of the process by which the position of the second user device 35 may be used to enable/disable and control the extent of the first angle α by means of control signalling. In some embodiments, the audio rendering module 24 may feedback data to the second user device 35 in order to indicate the state of the transformation, and may display a soft key for user disablement.

FIG. 7 is a flow chart indicating processing operations of a method that may be implemented by the server 10 in accordance with example embodiments.

A first operation 700 comprises identifying virtual audio content within a first spatial sector of a virtual space. A second operation comprises modifying the identified virtual audio content to be rendered in a second, smaller spatial sector.

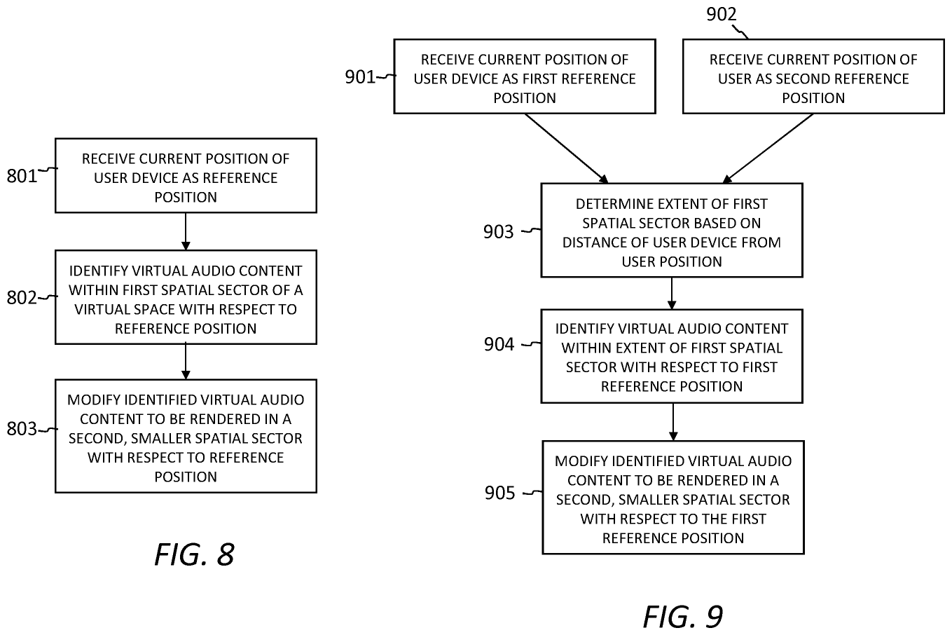

FIG. 8 is a flow chart indicating processing operations of a method that may be implemented by the server 10 in accordance with other example embodiments.

A first operation 801 comprises receiving a current position of a user device as a reference position. A second operation 802 comprises identifying virtual audio content within a first spatial sector of a virtual space, with respect to the reference position. A third operation 803 comprises modifying the identified virtual audio content to be rendered in a second, smaller spatial sector, with respect to the reference position.

FIG. 9 is a flow chart indicating processing operations of a method that may be implemented by the server 10 in accordance with example embodiments.

A first operation 901 comprises receiving the current position of a user device as a first reference positon. A second operation 902 comprises receiving a current position of a user as second reference position. The first and second operations may be performed in parallel or sequentially. Another operation 903 comprises determining the extent of a first spatial sector based on the distance (or some other relationship) between the user device and the user position. Another operation 904 comprises identifying virtual audio content within the first spatial sector with reference to the first reference position. Another operation 905 comprises modifying the identified virtual audio content to be rendered in a second, smaller spatial sector with reference to the first reference position.

It will be appreciated that the order of operations is not necessarily indicative of order of processing. Certain steps may be removed, replaced or added to.

In the above, it will be appreciated that the user position can be approximated by determining the position of the first user device 16.

The audio content described herein may be of any suitable form, and may comprise spatial audio or binaural audio, given merely by way of example. The volumetric content module 22 may store data representing said audio content in any suitable form. The audio content may be captured using known methods, for example using multiple microphones, cameras and/or the use of a spatial capture device comprising multiple cameras and microphones distributed is around a spherical body.

The ISO/IEC JTC1/SC29/WG11 or MPEG (Moving Picture Experts Group) is currently standardizing technology called MPEG-I, which will facilitate rendering of audio for 3 DoF, 3 DoF+ and 6 DoF scenarios as mentioned herein. The technology will be based on 23008-3:201×, MPEG-H 3D Audio Second Edition. MPEG-H 3D audio is used for core waveform carriage (e.g. encoding and decoding) in the form of objects, channels, and Higher-Order-Ambisonics (HOA). The goal of MPEG-I is to develop and standardize technologies comprising metadata over the core MPEG-H 3D and new rendering technologies to enable 3 DoF, 3 DoF+ and 6 DoF audio transport and rendering.

MPEG-I may comprise parametric metadata to enable 6 DOF rendering over an MPEG-H 3D audio bit stream.

For completeness, FIG. 10 depicts a system 200 for synthesizing a binaural output of an audio object, e.g. one of the audio sources 30a-30g. An input signal is fed to a delay line 202, and the direct sound and directional early reflections are read at suitable delays. The delays corresponding to early reflections can be obtained by analysing the time delays of the early reflections from a measured or idealized room impulse response. The direct sound is fed to a source directivity and/or distance/gain attenuation modelling filter Tₒ(z) 203. The attenuated and directionally-filtered direct sound is then passed to a reverberator 204. The output of the filter Tₒ(z) 203 is also fed to a set of head-related-transfer-function HRTF filters 206 which spatially positions the direct sound to the correct direction with respect to the user's head. The processing for the early reflections is analogous to the direct sound; these may be also subjected to level adjustment and directionality processing and then HRTF filtering to maintain their spatial position.

To create a multichannel reverberator, two sets of parameters, one for the left channel and one for the right channel are used to create incoherent outputs. Similarly, for loudspeaker reproduction there are as many reverberators as there are output channels.

Finally, the HRTF-filtered direct sound, early reflections and the non-HRTF-filtered reverberation are summed to produce the signals for the left and right ear for binaural reproduction.

Although not shown in FIG. 10, user head orientation, represented by yaw, pitch and roll can be used to update the directions of the direct sound and early reflections, as well as sound source directionality, depending on user head orientation.

Although not shown in FIG. 10, user position can be used to update the directions and distances to the direct sound and early reflections.

Distance rendering is in practise done by modifying the gain and direct-to-wet ratio (or direct-to-ambient ratio). For example, the direct signal gain can be modified according to 1/distance so that sounds which are farther away get quieter inversely proportionally to the distance. The direct-to-wet ratio decreases when objects get farther. A simple implementation can keep the wet gain constant within the listening space and then apply distance/gain attenuation only to the direct part.

Instead of audio objects, spatial audio can be encoded as audio signals with parametric side information. The audio signals can be, for example, B-format signals or mid-side stereo. Creating such a representation involves spatial analysis and/or metadata encoding steps, and then synthesis which utilizes the audio signals and the parametric metadata to synthesize the audio scene so that a desired spatial perception is created.

The spatial analysis/metadata encoding can refer to different techniques. For example, potential candidates are spatial audio capture (SPAC), as well as Directional Audio Coding (DirAC). The term DirAC specifies a technique that is a method for sound field capture similar to SPAC, although the technical methods to obtain the spatial metadata differ.

Metadata produced by a spatial analysis may comprise:
a direction parameter (azi, ele) in frequency bands; and/or
a diffuse-to-total energy ratio parameter in frequency bands.

The diffuse-to-total parameter is a ratio parameter, typically applied in context of DirAC, while in SPAC metadata, a direct-to-total ratio parameter is typically utilized. These parameters can be converted from one to the other, so that we may utilize a more generic term “ratio metadata” or “energy ratio metadata”.

For example, a capture implementation could produce such metadata.

It is well known in the field of spatial audio capture that the aforementioned metadata representation is particularly suitable in the context of perceptually motivated capturing or conveying of spatial sound from microphone arrays, which may be any device type including mobile phones, VR cameras, etc.

DirAC estimates the directions and diffuseness ratios (equivalent information to a direct-to-total ratio parameter) from a first-order Ambisonic (FOA) signal, or its variant, the B-format signal.

The FOA signal can be generated from a loudspeaker mix. The wᵢ(t), xᵢ(t), yᵢ(t), zᵢ(t) components of a FOA signal can be generated from a loudspeaker signal sᵢ(t) at aziᵢ and eleᵢ by

$${FOA}_{i} ( t ) = [ \begin{matrix}{w}_{i} ( t ) \\ {x}_{i} ( t ) \\ {y}_{i} ( t ) \\ {z}_{i} ( t )\end{matrix} ] = {s}_{i} ( t ) [ \begin{matrix}1 \\ cos ( az {i}_{i} ) cos ( {ele}_{i} ) \\ sin ( az {i}_{i} ) cos ( {ele}_{i} ) \\ sin ( {ele}_{i} )\end{matrix} ]$$

The w, x, y, z signals are generated for each loudspeaker (or object) signal sᵢ having its own azimuth and elevation direction. The output signal combining all such signals is Σᵢ₋₁^{NUM_CH} FOAᵢ(t)

The signals of Σᵢ₋₁^{NUM_CH} FOAᵢ(t) are transformed into frequency bands , for example by STFT , resulting in time-frequency signals w(k,n), x(k,n), y(k,n), z(k,n), where k is the frequency bin index and n is the time index. DirAC estimates the intensity vector by

$$I ( k , n ) = Re \{ {w}^{*} ( k , n ) [ \begin{matrix}x ( k , n ) \\ y ( k , n ) \\ z ( k , n )\end{matrix} ] \}$$

where Re means real-part, and asterisk*means complex conjugate. The intensity expresses the direction of the propagating sound energy, and thus the direction parameter is the opposite direction of the intensity vector. The intensity vector may be averaged over several time and/or frequency indices prior to the determination of the direction parameter.

DirAC determines the diffuseness as

$$ψ ( k , n ) = 1 - \frac{E [ \vert I ( k , n ) \vert ]}{E [ 0.5 ( {w}^{2} ( k , n ) + {x}^{2} ( k , n ) + {y}^{2} ( k , n ) + {z}^{2} ( k , n ) ) ]}$$

Diffuseness is a ratio value that is 1 when the sound is fully ambient, and o when the sound is fully directional. Again, all parameters in the equation are typically averaged over time and/or frequency. The expectation operator E[] can be replaced with an average operator in practical systems.

An alternative ratio parameter is the direct-to-total energy ratio, which can be obtained as

r(k,n)=1−ψ(k,n)

When averaged, the diffuseness (and direction) parameters typically are determined in frequency bands combining several frequency bins k, for example, approximating the Bark frequency resolution.

DirAC, as determined above, is only one of the options to determine the directional and ratio metadata, and clearly one may utilize other methods to determine the metadata, for example by simulating a microphone array and using SPAC algorithms. Furthermore, there are also many variants of DirAC.

Spatial sound reproduction requires positioning sound in 3D space to arbitrary directions. Vector base amplitude panning (VBAP) is a common method to position spatial audio signals using loudspeaker setups.

VBAP is based on:

1) automatically triangulating the loudspeaker setup;

2) selecting an appropriate triangle based on the direction, such that for a given direction, three loudspeakers are selected which form a triangle where the given direction falls in; and

3) computing gains for the three loudspeakers forming the particular triangle.

In a practical implementation, VBAP gains (for each azimuth and elevation) and the loudspeaker triplets (for each azimuth and elevation) may be pre-formulated into a lookup table stored in the memory. A real-time system then performs the amplitude panning by finding from the memory the appropriate loudspeaker triplet for the desired panning direction, and the gains for these loudspeakers corresponding to the desired panning direction.

The vector base amplitude panning refers to the method where three unit vectors l₁, l₂, l₃ (the vector base) are assumed from the point of origin to the positions of the three loudspeakers forming the triangle where the panning direction falls in.

The panning gains for the three loudspeakers are determined such that these three unit vectors are weighted such that their weighted sum vector points towards the desired amplitude panning direction. This can be solved as follows. A column unit vector p is formulated pointing towards the desired amplitude panning direction, and a vector g containing the amplitude panning gains can be solved by a matrix multiplication

$${g}^{T} = {{p}^{T} [ \begin{matrix}{l}_{1}^{T} \\ {l}_{2}^{T} \\ {l}_{3}^{T}\end{matrix} ]}^{- 1} .$$

Where ⁻¹ denotes the matrix inverse. After formulating gains g, their overall level is normalized such that for the final gains the energy sum g^{T}g=1;

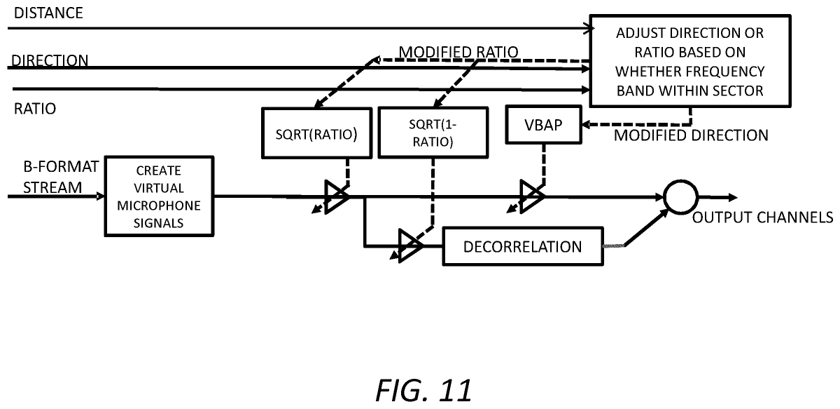

FIG. 11 depicts an example where methods and systems of example embodiments are used to render parametric spatial audio content, as mentioned above. The parametric representation can be DirAC or SPAC or other suitable parameterization.

In the baseline parametric spatial audio synthesis, the panning directions for the direct portion of the sound are determined based on the direction metadata. The diffuse portion may be synthesized evenly to all loudspeakers. The diffuse portion may be created by decorrelation filtering, and the ratio metadata may control the energy ratio of the direct sound and the diffuse sound.

The system shown in FIG. 11 may modify the reproduction of the direct portion of parametric spatial audio. The principle is similar to the rendering of the spatial sources in other embodiments; the rendering for the portion of the spatial audio content within the sector is modified compared to rendering of spatial audio outside the sector. Here, instead of spatial sources as objects, the rendering is done for time-frequency tiles. Thus, this embodiment modifies the rendering, more specifically, controls the directions and ratios for those time-frequency tiles which have modified spatial positions because of applying the virtual wide angle lens. When a time-frequency tile is translated, its direction is modified, to and if its distance from the user changes the ratio may be changed as well (as the time-frequency tile moves closer, the ratio is increased, and vice versa).

Determination of whether a time-frequency tile is within the sector or not can be done using the direction data, which indicates the sound direction of arrival. If the direction of arrival for the time-frequency tile is within the sector, then modification to the direction of arrival and the ratio is applied.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-15. (canceled)

16. An apparatus comprising:
at least one processor; and
at least one memory including computer program code,
the at least one memory and the computer program code configured to, with the at least one processor, cause the apparatus to perform at least the following:
identify virtual audio content within a first spatial sector of a virtual space with respect to a reference position; and
modify the identified virtual audio content to be rendered in a second, smaller spatial sector.

17. The apparatus of claim 16, wherein the second spatial sector is wholly within the first spatial sector.

18. The apparatus of claim 16, wherein virtual audio content outside of the first spatial sector is not modified or is modified differently than the identified virtual audio content.

19. The apparatus of claim 16, wherein the apparatus is further configured to provide the virtual audio content to a first user device associated with a user, detect a predetermined first condition of a second user device associated with the user, and modify the identified virtual audio content responsive to detection of the predetermined first condition.

20. The apparatus of claim 19, wherein the apparatus is further configured to detect a predetermined second condition of the first or second user device, and if the virtual audio content has been modified, to revert back to rendering the identified virtual audio content in unmodified form responsive to detection of the predetermined second condition.

21. The apparatus of claim 16, wherein the apparatus is further configured to identify one or more audio sources, associated with respective virtual audio content, being within the first spatial sector, and modify the spatial position of the virtual audio content to be rendered from within the second spatial sector.

22. The apparatus of claim 16, wherein the apparatus is further configured to receive a current position of a user device associated with a user in relation to the virtual space and use said current position as the reference position and to determine the first spatial sector as an angular sector of the space for which the reference position is the origin.

23. The apparatus of claim 22, wherein the second spatial sector is a smaller angular sector of the space for which the reference position is also the origin.

24. The apparatus of claim 22, wherein the determined angular sector is based on the movement or distance of the user device with respect to a user.

25. The apparatus of claim 16, wherein the apparatus is further configured to move the respective spatial positions of the identified virtual audio content by translation towards a line passing through the centre of the first or second spatial sectors.

26. The apparatus of claim 16, wherein the apparatus is further configured to move the respective spatial positions of the identified virtual audio content for the identified audio sources by rotation about an arc of substantially constant radius from the reference position.

27. The apparatus of claim 16, wherein the apparatus is further configured to render virtual video content in association with the virtual audio content, in which the virtual video content for the identified audio content is not spatially modified.

28. The apparatus of claim 16, where in the apparatus is a mobile phone.

29. A method, comprising:
identifying virtual audio content within a first spatial sector of a virtual space with respect to a reference position; and
modifying the identified virtual audio content to be rendered in a second, smaller spatial sector.

30. The method of claim 29, wherein the second spatial sector is wholly within the first spatial sector.

31. The method of claim 29, wherein virtual audio content outside of the first spatial sector is not modified or is modified differently than the identified virtual audio content.

32. The methods of claim 29, further comprising providing the virtual audio content to a first user device associated with a user, detecting a predetermined first condition of a second user device associated with the user, and modifying the identified virtual audio content responsive to detection of the predetermined first condition.

33. The method of claim 32, further comprising detecting a predetermined second condition of the first or second user device, and if the virtual audio content has been modified, reverting back to rendering the identified virtual audio content in unmodified form responsive to detection of the predetermined second condition.

34. The method of claim 29, further comprising identifying one or more audio sources, associated with respective virtual audio content, being within the first spatial sector, and modifying the spatial position of the virtual audio content to be rendered from within the second spatial sector.

35. A non-transitory computer readable medium comprising program instructions stored thereon for performing at least the following:
identifying virtual audio content within a first spatial sector of a virtual space with respect to a reference position; and
modifying the identified virtual audio content to be rendered in a second, smaller spatial sector.
